(19) United States
(12) Patent Application Publication
(10) Pub. No.: US 2026/0056349 A1
(43) Pub. Date: Feb. 26, 2026

(54) OPTICAL GLASS, OPTICAL ELEMENT AND OPTICAL INSTRUMENT

(71) Applicant: CDGM Glass Co., Ltd, Chengdu (CN)

(72) Inventors: Bo KUANG, Chengdu (CN); Jinwei Wu, Chengdu (CN)

(73) Assignee: CDGM Glass Co., Ltd, Chengdu (CN)

(21) Appl. No.: 19/289,569

(22) Filed: Aug. 4, 2025

(30) Foreign Application Priority Data
Aug. 22, 2024 (CN) 2024111581435

(51) Int. Cl. G02B 1/02; C03C 3/17; C03C 3/19; C03C 3/21

(52) U.S. Cl. CPC G02B 1/02; C03C 3/17; C03C 3/19; C03C 3/21

(57) ABSTRACT

An optical glass, wherein components thereof are represented by weight percentage, including: 20-34% of P₂O₅; 38-53% of Nb₂O₅; 8-22% of TiO₂; 1-12% of Na₂O; 0-10% of K₂O; 0-8% of BaO. Through rational component design, the optical glass of the present invention exhibits high refractive index while having low density, which is conducive to achieving the lightweight feature of optical instruments.

### TECHNICAL FIELD

The present invention relates to an optical glass, in particular to an optical glass with high refractive index and low density, as well as an optical element and an optical instrument made of the optical glass.

### BACKGROUND

In recent years, augmented reality (AR) technology has received considerable attention. Its near-eye display system forms a distant virtual image from the pixels on the display through a series of optical imaging components and projects it into the human eye. In AR glasses, total reflection is the key to ensure no loss or leakage of light during transmission; that is, the light reflects back and forth within the waveguide without transmitting outward. In short, a larger field of view requires a glass substrate with a higher refractive index. Therefore, the glass substrate with high refractive index is particularly critical. Meanwhile, under the same curvature radius, the glass with higher refractive index can obtain a larger imaging field of view, which is conducive to reducing the number of optical elements in the optical instrument. With the development trend toward lightweight optical instruments, the demand for high-refractive-index and high-dispersion optical glasses having a refractive index of 1.89-1.95 and an Abbe number of 15-22 is increasing.

To enable prolonged wear of AR glasses, it is necessary to make the AR glasses lighter, which can be achieved by reducing the weight of the optical glass therein. Such weight reduction also offers advantages in many other application fields, such as optical instruments that use many optical elements, like digital camera. If the density of the optical glass is too high, it will significantly increase the demand for battery power required in auto-focusing. Therefore, as high-end optoelectronic products continue to advance, the demand for lower-density optical glass is increasing. CN1915876A discloses a high-refractive-index and high-dispersion optical glass having a refractive index of 1.86-1.95, an Abbe number of 19-24, and a high density, which is not conductive to achieve the lightweight feature of optical instruments.

### SUMMARY

A technical problem to be solved by the present invention is to provide an optical glass with a high refractive index and a low density.

To solve the technical problem, the technical scheme of the present invention provides:

An optical glass, wherein components thereof are represented by weight percentage, comprising: 20-34% of P₂O₅; 38-53% of Nb₂O₅; 8-22% of TiO₂; 1-12% of Na₂O; 0-10% of K₂O; 0-8% of BaO.

Furthermore, the optical glass, wherein components thereof are represented by weight percentage, further comprising: 0-8% of CaO; and/or 0-5% of MgO; and/or 0-5% of SrO; and/or 0-6% of Li₂O; and/or 0-5% of SiO₂; and/or 0-5% of B₂O₃; and/or 0-5% of ZrO₂; and/or 0-5% of Al₂O₃; and/or 0-5% of ZnO; and/or 0-5% of WO₃; and/or 0-5% of Ln₂O₃; and/or 0-5% of Bi₂O₃; and/or 0-1% of clarifying agent, and the Ln₂O₃ is one or more of La₂O₃, Gd₂O₃, Y₂O₃ and Yb₂O₃, and the clarifying agent is one or more of Sb₂O₃, SnO₂, SnO and CeO₂.

An optical glass, wherein components thereof are represented by weight percentage, consisting of: 20-34% of P₂O₅; 38-53% of Nb₂O₅; 8-22% of TiO₂; 1-12% of Na₂O; 0-10% of K₂O; 0-8% of BaO; 0-8% of CaO; 0-5% of MgO; 0-5% of SrO; 0-6% of Li₂O; 0-5% of SiO₂; 0-5% of B₂O₃; 0-5% of ZrO₂; 0-5% of Al₂O₃; 0-5% of ZnO; 0-5% of WO₃; 0-5% of Ln₂O₃; 0-5% of Bi₂O₃; and 0-1% of clarifying agent, the Ln₂O₃ is one or more of La₂O₃, Gd₂O₃, Y₂O₃ and Yb₂O₃, and the clarifying agent is one or more of Sb₂O₃, SnO₂, SnO and CeO₂.

Furthermore, the optical glass, wherein components thereof are represented by weight percentage, in which: P₂O₅/Nb₂O₅ is 0.4-0.85, preferably P₂O₅/Nb₂O₅ is 0.45-0.8, more preferably P₂O₅/Nb₂O₅ is 0.5-0.7, further preferably P₂O₅/Nb₂O₅ is 0.55-0.65.

Furthermore, the optical glass, wherein components thereof are represented by weight percentage, in which: TiO₂/Nb₂O₅ is 0.2-0.55, preferably TiO₂/Nb₂O₅ is 0.2-0.5, more preferably TiO₂/Nb₂O₅ is 0.25-0.45.

Furthermore, the optical glass, wherein components thereof are represented by weight percentage, in which: TiO₂/K₂O is 1.0-18.0, preferably TiO₂/K₂O is 1.0-12.0, more preferably TiO₂/K₂O is 1.5-10.0, further preferably TiO₂/K₂O is 2.0-8.0.

Furthermore, the optical glass, wherein components thereof are represented by weight percentage, in which: (Nb₂O₅+Na₂O+BaO)/TiO₂ is 1.8-5.5, preferably (Nb₂O₅+Na₂O+BaO)/TiO₂ is 2.0-5.0, more preferably (Nb₂O₅+Na₂O+BaO)/TiO₂ is 2.5-4.5.

Furthermore, the optical glass, wherein components thereof are represented by weight percentage, in which: (TiO₂+K₂O)/(BaO+Na₂O) is 1.6-12.0, preferably (TiO₂+K₂O)/(BaO+Na₂O) is 2.0-10.0, more preferably (TiO₂+K₂O)/(BaO+Na₂O) is 2.2-7.0, further preferably (TiO₂+K₂O)/(BaO+Na₂O) is 2.5-5.5.

Furthermore, the optical glass, wherein components thereof are represented by weight percentage, in which: CaO/BaO is 0.1-10.0, preferably CaO/BaO is 0.2-7.0, more preferably CaO/BaO is 0.3-5.0, further preferably CaO/BaO is 0.5-3.0.

Furthermore, the optical glass, wherein components thereof are represented by weight percentage, in which: (B₂O₃+SiO₂)/CaO is 2.8 or less, preferably (B₂O₃+SiO₂)/CaO is 0.1-2.0, more preferably (B₂O₃+SiO₂)/CaO is 0.2-1.5, further preferably (B₂O₃+SiO₂)/CaO is 0.4-1.0.

Furthermore, the optical glass, wherein components thereof are represented by weight percentage, in which: (BaO+SrO+MgO+ZnO+ZrO₂)/Na₂O is 1.0 or less, preferably (BaO+SrO+MgO+ZnO+ZrO₂)/Na₂O is 0.8 or less, more preferably (BaO+SrO+MgO+ZnO+ZrO₂)/Na₂O is 0.05-0.6, further preferably (BaO+SrO+MgO+ZnO+ZrO₂)/Na₂O is 0.1-0.5.

Furthermore, the optical glass, wherein components thereof are represented by weight percentage, in which: (BaO+WO₃)/K₂O is 1.5 or less, preferably (BaO+WO₃)/K₂O is 1.0 or less, more preferably (BaO+WO₃)/K₂O is 0.05-0.7, further preferably (BaO+WO₃)/K₂O is 0.1-0.5.

Furthermore, the optical glass, wherein components thereof are represented by weight percentage, in which: WO₃/CaO is 0.9 or less, WO₃/CaO is preferably 0.7 or less, WO₃/CaO is more preferably 0.5 or less, WO₃/CaO is further preferably 0.3 or less.

Furthermore, the optical glass, wherein components thereof are represented by weight percentage, in which:
(B₂O₃+SiO₂+Al₂O₃+WO₃+ZnO+ZrO₂+Ln₂O₃+Bi₂O₃)/(BaO+CaO) is 1.7 or less, preferably (B₂O₃+SiO₂+Al₂O₃+WO₃+ZnO+ZrO₂+Ln₂O₃+Bi₂O₃)/(BaO+CaO) is 1.0 or less, more preferably
(B₂O₃+SiO₂+Al₂O₃+WO₃+ZnO+ZrO₂+Ln₂O₃+Bi₂O₃)/(BaO+CaO) is 0.7 or less, further preferably
(B₂O₃+SiO₂+Al₂O₃+WO₃+ZnO+ZrO₂+Ln₂O₃+Bi₂O₃)/(BaO+CaO) is 0.1-0.6, and the Ln₂O₃ is one or more of La₂O₃, Gd₂O₃, Y₂O₃ and Yb₂O₃.

Furthermore, the optical glass, wherein components thereof are represented by weight percentage, in which: P₂O₅ is 22-32%, preferably P₂O₅ is 25-29%; and/or Nb₂O₅ is 40-50%, preferably Nb₂O₅ is 42-47%; and/or TiO₂ is 11-20%, preferably TiO₂ is 13-18%; and/or Na₂O is 2-10%, preferably Na₂O is 3-8%; and/or K₂O is 0.5-8%, preferably K₂O is 1-6%; and/or BaO is greater than 0 but less than or equal to 6%, preferably BaO is 0.1-3.5%; and/or CaO is 0-6%, preferably CaO is 0.1-4%; and/or MgO is 0-3%, preferably MgO is 0-1%, more preferably not contained; and/or SrO is 0-3%, preferably SrO is 0-1%, more preferably not contained; and/or Li₂O is 0-4%, preferably Li₂O is 0-2%, more preferably not contained; and/or SiO₂ is 0-3%, preferably SiO₂ is 0-1%; and/or B₂O₃ is 0-3%, preferably B₂O₃ is 0-1.5%; and/or ZrO₂ is 0-3%, preferably ZrO₂ is 0-1%, more preferably not contained; and/or Al₂O₃ is 0-3%, preferably Al₂O₃ is 0-1%, more preferably not contained; and/or ZnO is 0-3%, preferably ZnO is 0-1%, more preferably not contained; and/or WO₃ is 0-3%, preferably WO₃ is 0-1%, more preferably not contained; and/or Ln₂O₃ is 0-3%, preferably Ln₂O₃ is 0-1%, more preferably not contained; and/or Bi₂O₃ is 0-3%, preferably Bi₂O₃ is 0-1%, more preferably not contained; and/or 0-0.5% of clarifying agent, preferably 0-0.1% of clarifying agent, and the Ln₂O₃ is one or more of La₂O₃, Gd₂O₃, Y₂O₃ and Yb₂O₃, and the clarifying agent is one or more of Sb₂O₃, SnO₂, SnO and CeO₂.

Furthermore, refractive index n_{d} of the optical glass is 1.89-1.95, preferably 1.90-1.95, more preferably 1.91-1.94, further preferably 1.915-1.93; and Abbe number νd is 15-22, preferably 16-21, more preferably 17-20, further preferably 17.5-19.5.

Furthermore, a thermal expansion coefficient α_{100/300° C.} of the optical glass is 100×10⁻⁷/K or less, preferably 90×10⁻⁷/K or less, more preferably 85×10⁻⁷/K or less; and/or acid resistance stability D_{A} is Class 2 or above, preferably Class 1; and/or water resistance stability D_{W} is Class 2 or above, preferably Class 1; and/or transition temperature T_{g} is 680° C. or less, preferably 670° C. or less, more preferably 665° C. or less, further preferably 660° C. or less; and/or abrasion degree F_{A} is 160-220, preferably 170-210, more preferably 180-200; and/or density p is 3.80 g/cm³ or less, preferably 3.70 g/cm³ or less, more preferably 3.60 g/cm³ or less, further preferably 3.50 g/cm³ or less; and/or λ₇₀ is 450 nm or less, preferably λ₇₀ is 445 nm or less, more preferably λ₇₀ is 440 nm or less; and/or weather resistance CR is Class 2 or above, preferably Class 1; and/or Young's modulus E is 9000×10⁷ Pa or more, preferably 9500×10⁷ Pa or more, more preferably 9800×10⁷ Pa or more, further preferably 10000×10⁷ Pa-11000×10⁷ Pa; and/or bubble degree is Class A or above, preferably Class A₀ or above, more preferably A₀₀; and/or stripe degree is Grade C or above, preferably Grade B or above; and/or crystallization resistance of secondary compression is Grade C or above, preferably Grade B or above, more preferably Grade A.

A glass preform is made of the above-mentioned optical glass.

An optical element, made of the above-mentioned optical glass or made of the above-mentioned glass preform.

An optical instrument, comprising the above-mentioned optical glass, or comprising the above-mentioned optical element.

The beneficial effects of the present invention are as follows: Through rational component design, the optical glass of the present invention exhibits high refractive index performance while having low density, which is conducive to achieving the lightweight feature of optical instruments.

### DETAILED DESCRIPTION

The implementations of the optical glass provided by the present invention will be described in detail below, but the present invention is not limited to the following implementations. Appropriate changes may be made within the scope of the purpose of the present invention for implementation. In addition, the repeated descriptions will not limit the aim of the invention although with appropriate omissions. In the following, the optical glass of the present invention is sometimes referred to as glass.

### [Optical Glass]

Hereinafter, the components (ingredients) of the optical glass provided by the present invention will be described. If not specified herein, the content of each component, the total content, and the overall content are expressed in weight percentage (wt %); that is, the content of each component, the overall content, and the total content are expressed in weight percentage relative to the total glass substances converted into oxide composition. “Converted into oxide composition” therein refers to that the total weight of this oxide is taken as 100% when the oxide, compound salt and hydroxide, used as raw materials for the composition of the optical glass of the present invention, are decomposed and transformed into oxides during melting.

Unless otherwise noted in specific circumstances, the numerical range listed herein includes upper and lower limits, and the words “above” and “below” include the endpoint values as well as all integers and fractions within the range, but not limited to the specific values listed when the range is limited. “And/or” mentioned herein is inclusive. For example, “A and/or B” refers to only A, or only B, or both A and B.

### <Necessary Components and Optional Components>

P₂O₅ serves as a network former of the glass of the present invention. Compared to silicate glass, phosphate glass can melt at lower temperature, which is conductive to improving the light transmittance of the glass. However, if the content of P₂O₅ is too high, it will result in a flatter viscosity-temperature curve in the glass molding zone, thereby slowing down the cooling and solidification process during glass molding. This is particularly unfavorable for the molding of large-sized glass. A high content of P₂O₅ tends to volatilize, which is not conducive to obtaining the good stripe degree in the glass. Therefore, the content of P₂O₅ is 20-34%, preferably 22-32%, more preferably 25-29%. In some implementations, the content of P₂O₅ may be 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%, 30.5%, 31%, 31.5%, 32%, 32.5%, 33%, 33.5% or 34%.

Nb₂O₅, a high-refraction high-dispersion component, can increase the refractive index and chemical stability of the glass,. The present invention obtains the above effect by comprising 38% or more of Nb₂O₅. The content of Nb₂O₅ is preferably 40% or more, more preferably 42% or more. If the content of Nb₂O₅ is too high, the devitrification resistance performance of the glass will decrease, and the density will increase. Therefore, in the present invention, the upper limit of the Nb₂O₅ content is 53%, preferably 50%, more preferably 47%. In some implementations, the content of Nb₂O₅ may be 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%, 50%, 50.5%, 51%, 51.5%, 52%, 52.5% or 53%.

In some implementations, the ratio of the content of P₂O₅ to the content of Nb₂O₅, i.e., P₂O₅/Nb₂O₅, is controlled to be within a range of 0.4-0.85 facilitates achieving the desired optical constant, which optimizes the bubble degree while reducing the thermal expansion coefficient of the glass. Therefore, P₂O₅/Nb₂O₅ is preferably 0.4-0.85, P₂O₅/Nb₂O₅ is more preferably 0.45-0.8, P₂O₅/Nb₂O₅ is further preferably 0.5-0.7, and P₂O₅/Nb₂O₅ is more further preferably 0.55-0.65. In some implementations of the present invention, the value of P₂O₅/Nb₂O₅ can be 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84 or 0.85.

TiO₂ can increase the refractive index and dispersion of the glass and improve the devitrification resistance. An appropriate introduction of TiO₂ in the present invention can make the glass more stable and reduce the high-temperature viscosity of the glass. The present invention obtains the above effect by comprising 8% or more of TiO₂, preferably comprising 11% or more of TiO₂, more preferably comprising 13% or more of TiO₂. If the content of TiO₂ exceeds 22%, the glass will exhibit an increased tendency for devitrification and coloration, and the transition temperature will rise. Therefore, the content of TiO₂ is 22% or less, preferably 20% or less, more preferably 18% or less. In some implementations, the content of TiO₂ may be 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5% or 22%.

In some implementations, the ratio of the content of TiO₂ to the content of Nb₂O₅, i.e., TiO₂/Nb₂O₅, is controlled to be within a range of 0.2-0.55, which can increase the weather resistance and Young's modulus of the glass while preventing a decrease in the transmittance of the glass. Therefore, TiO₂/Nb₂O₅ is preferably 0.2-0.55, TiO₂/Nb₂O₅ is more preferably 0.2-0.5, TiO₂/Nb₂O₅ is further preferably 0.25-0.45. In some implementations of the present invention, the value of TiO₂/Nb₂O₅ can be 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54 or 0.55.

Na₂O can improve the melting performance and light transmittance of the glass, and meanwhile can decrease the transition temperature of the glass. If the content of Na₂O is too high, the chemical stability and weather resistance of the glass will decrease. Therefore, the content of Na₂O is 1-12%, preferably 2-10%, more preferably 3-8%. In some implementations, the content of Na₂O may be 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5% or 12%.

K₂O can improve the devitrification resistance and melting performance of the glass. If the content of K₂O is too high, the glass will be difficult to achieve the desired high refractive index and high dispersion performance. Therefore, the content of K₂O is 0-10%, preferably 0.5-8%, more preferably 1-6%. In some implementations, the content of K₂O may be 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10%.

In some implementations, the ratio of the content of TiO₂ to the content of K₂O, i.e., TiO₂/K₂O, is controlled to be within a range of 1.0-18.0, which can increase the weather resistance and the crystallization resistance of secondary compression of the glass. Therefore, TiO₂/K₂O is preferably 1.0-18.0, and TiO₂/K₂O is more preferably 1.0-12.0. Furthermore, TiO₂/K₂O is controlled within a range of 1.5-10.0, which can also further optimize the Young's modulus of the glass. Therefore, TiO₂/K₂O is further preferably 1.5-10.0, and TiO₂/K₂O is more further preferably 2.0-8.0. In some implementations of the present invention, the value of TiO₂/K₂O can be 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5 or 18.0.

Li₂O can reduce the transition temperature of the glass. However, if the content of Li₂O is high, it will not be conducive to the acid resistance stability thermal expansion coefficient of the glass. In addition, it causes corrosion to melting vessels (such as platinum crucibles). Therefore, the content of Li₂O is 6% or less, preferably 4% or less, more preferably 2% or less. In some implementations, it further preferably contains no Li₂O. In some implementations, the content of Li₂O may be 0%, greater than 0%, 0.01%, 0.05%, 0.1%, 0.5%, 1%, 1.5%, 2%, 2.5%, 3%, 3.5%, 4%, 4.5%, 5%, 5.5% or 6%.

BaO can improve the devitrification resistance and light transmittance of the glass, and improve the crystallization resistance of secondary compression of the glass in the present invention. However, if the content of BaO is too high, the chemical stability of the glass will become poor and the density will be increase. Therefore, the content of BaO is 0-8%, preferably greater than 0 but less than or equal to 6%, more preferably 0.1-3.5%. In some implementations, the content of BaO may be 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5% or 8%.

In some implementations, the ratio of the total content of Nb₂O₅, Na₂O, and BaO (Nb₂O₅+Na₂O+BaO) to the content of TiO₂, i.e., (Nb₂O₅+Na₂O+BaO)/TiO₂, is controlled to be within a range of 1.8-5.5, which can increase the bubble degree and stripe degree of the glass and prevent the thermal expansion coefficient from increasing. Therefore, (Nb₂O₅+Na₂O+BaO)/TiO₂ is preferably 1.8-5.5, (Nb₂O₅+Na₂O+BaO)/TiO₂ is more preferably 2.0-5.0, (Nb₂O₅+Na₂O+BaO)/TiO₂ is further preferably 2.5-4.5. In some implementations of the present invention, the value of (Nb₂O₅+Na₂O+BaO)/TiO₂ can be 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4 or 5.5.

In some implementations, the ratio of the total content of TiO₂ and K₂O (TiO₂+K₂O) to the total content of BaO and Na₂O (BaO+Na₂O), i.e., (TiO₂+K₂O)/(BaO+Na₂O), is controlled within a range of 1.6-12.0, which can reduce the thermal expansion coefficient of the glass and enhance the bubble degree of the glass. Therefore, (TiO₂+K₂O)/(BaO+Na₂O) is preferably 1.6-12.0, and (TiO₂+K₂O)/(BaO+Na₂O) is more preferably 2.0-10.0. Furthermore, (TiO₂+K₂O)/(BaO+Na₂O) is controlled to be within a range of 2.2-7.0, which can also further optimize the abrasion degree of the glass. Therefore, (TiO₂+K₂O)/(BaO+Na₂O) is further preferably 2.2-7.0, and (TiO₂+K₂O)/(BaO+Na₂O) is more further preferably 2.5-5.5. In some implementations of the present invention, the value of (TiO₂+K₂O)/(BaO+Na₂O) can be 1.6, 1.7, 1.8, 1.9, 2.0, 2.1, 2.2, 2.3, 2.4, 2.5, 2.6, 2.7, 2.8, 2.9, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5 or 12.0.

SrO can improve the devitrification resistance of the glass and improve the melting performance of the glass. However, if the content of SrO is too high, the refractive index of the glass is difficult to meet the design requirements, and meanwhile the cost of the glass will also rise rapidly. Therefore, the content of SrO is 0-5%, preferably 0-3%, more preferably 0-1%. In some implementations, it further preferably contains no SrO. In some implementations, the content of SrO may be 0%, greater than 0%, 0.01%, 0.05%, 0.1%, 0.5%, 1%, 1.5%, 2%, 2.5%, 3%, 3.5%, 4%, 4.5% or 5%.

CaO helps to improve the light transmittance and density of the glass. However, in case of excessive CaO content, the optical constant of the glass will be difficult to meet the design requirements, and the devitrification resistance performance will deteriorate. Therefore, the content of CaO is 0-8%, preferably 0-6%, more preferably 0.1-4%. In some implementations, the content of CaO may be 0%, greater than 0%, 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5% or 8%.

In some implementations, the ratio of the content of CaO to the content of BaO, i.e., CaO/BaO, is controlled to be within a range of 0.1-10.0, which can reduce the density of the glass while improving the chemical stability and the crystallization resistance of secondary compression of the glass. Therefore, CaO/BaO is preferably 0.1-10.0, CaO/BaO is more preferably 0.2-7.0, CaO/BaO is further preferably 0.3-5.0, and CaO/BaO is more further preferably 0.5-3.0. In some implementations of the present invention, the value of CaO/BaO can be 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or 10.0.

MgO can reduce the relative partial dispersion of the glass. However, if the content of MgO is too high, the refractive index of the glass is difficult to meet the design requirements, and the devitrification resistance performance and the stability of the glass will decrease. Therefore, the content of MgO is 0-5%, preferably 0-3%, more preferably 0-1%. In some implementations, it further preferably contains no MgO. In some implementations, the content of MgO may be 0%, greater than 0%, 0.01%, 0.05%, 0.1%, 0.5%, 1%, 1.5%, 2%, 2.5%, 3%, 3.5%, 4%, 4.5% or 5%.

SiO₂ is conductive to increasing the molding viscosity of the glass and improving the stripe degree of the glass, and facilitates the use of quartz crucibles for preparing clinker to avoid platinum contamination, thereby improving the transmittance of the glass. However, if the content of SiO₂ is too high, the melting temperature of the glass and the transition temperature of the glass will rise. Therefore, the content of SiO₂ is 0-5%, preferably 0-3%, more preferably 0-1%. In some implementations, the content of SiO₂ may be 0%, greater than 0%, 0.01%, 0.05%, 0.1%, 0.5%, 1%, 1.5%, 2%, 2.5%, 3%, 3.5%, 4%, 4.5% or 5%.

B₂O₃ can improve the stability and melting performance of the glass. If the content of B₂O₃ is too high, the refractive index of the glass will decrease, and the crystallization resistance of secondary compression will become poor. Therefore, the content of B₂O₃ in the present invention is 5% or less, preferably 3% or less, more preferably 1.5% or less. In some implementations, the content of B₂O₃ may be 0%, greater than 0%, 0.01%, 0.05%, 0.1%, 0.5%, 1%, 1.5%, 2%, 2.5%, 3%, 3.5%, 4%, 4.5% or 5%.

In some implementations, the ratio of the total content of B₂O₃ and SiO₂ (B₂O₃+SiO₂) to the content of CaO, i.e., (B₂O₃+SiO₂)/CaO, is controlled to be 2.8 or less, which can increase the stripe degree of the glass and prevent the decrease in the crystallization resistance of secondary compression of the glass. Therefore, (B₂O₃+SiO₂)/CaO is preferably 2.8 or less, and (B₂O₃+SiO₂)/CaO is more preferably 0.1-2.0. Furthermore, (B₂O₃+SiO₂)/CaO is controlled to be within a range of 0.2-1.5, which can also further optimize the weather resistance and staining degree of the glass. Therefore, (B₂O₃+SiO₂)/CaO is further preferably 0.2-1.5, and (B₂O₃+SiO₂)/CaO is more further preferably 0.4-1.0. In some implementations of the present invention, the value of (B₂O₃+SiO₂)/CaO can be 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2.0, 2.1, 2.2, 2.3, 2.4, 2.5, 2.6, 2.7 or 2.8.

ZrO₂ can improve the refractive index of the glass, adjust the dispersion, and increase the devitrification resistance performance and strength of the glass. If the content of ZrO₂ is too high, the melting difficulty of the glass will increase, the melting temperature will rise, and it may even lead to the formation of inclusions inside the glass and a decrease in transmittance. Therefore, the content of ZrO₂ is 5% or less, preferably 3%, more preferably 1% or less. In some implementations, it further preferably contains no ZrO₂. In some implementations, the content of ZrO₂ may be 0%, greater than 0%, 0.01%, 0.05%, 0.1%, 0.5%, 1%, 1.5%, 2%, 2.5%, 3%, 3.5%, 4%, 4.5% or 5%.

Al₂O₃ can improve the chemical stability of the glass, but when the content of Al₂O₃ exceeds 5%, the melting performance and light transmittance of the glass will deteriorate. Therefore, the content of Al₂O₃ in the present invention is 0-5%, preferably 0-3%, more preferably 0-1%. In some implementations, it further preferably contains no Al₂O₃. In some implementations, the content of Al₂O₃ may be 0%, greater than 0%, 0.01%, 0.05%, 0.1%, 0.5%, 1%, 1.5%, 2%, 2.5%, 3%, 3.5%, 4%, 4.5% or 5%.

ZnO can reduce the transition temperature of the glass, improve the chemical stability of the glass, and reduce the high-temperature viscosity of the glass. However, if the content of ZnO is too high, the crystallization resistance performance of the glass will become poor, and devitrification may easily occur due to the excessively low viscosity. Therefore, the content of ZnO is 0-5%, preferably 0-3%, more preferably 0-1%. In some implementations, it further preferably contains no ZnO. In some implementations, the content of ZnO may be 0%, greater than 0%, 0.01%, 0.05%, 0.1%, 0.5%, 1%, 1.5%, 2%, 2.5%, 3%, 3.5%, 4%, 4.5% or 5%.

In some implementations, the ratio of the total content of BaO, SrO, MgO, ZnO, and ZrO₂ (BaO+SrO+MgO+ZnO+ZrO₂) to the content of Na₂O, i.e., (BaO+SrO+MgO+ZnO+ZrO₂)/Na₂O, to be 1.0 or less, the stripe degree of the glass can be improved, and the abrasion degree of the glass can be improved. Therefore, (BaO+SrO+MgO+ZnO+ZrO₂)/Na₂O is preferably 1.0 or less, (BaO+SrO+MgO+ZnO+ZrO₂)/Na₂O is more preferably 0.8 or less, (BaO+SrO+MgO+ZnO+ZrO₂)/Na₂O is further preferably 0.05-0.6, and (BaO+SrO+MgO+ZnO+ZrO₂)/Na₂O is more further preferably 0.1-0.5. In some implementations of present the invention, the value of (BaO+SrO+MgO+ZnO+ZrO₂)/Na₂O can be 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95 or 1.0.

WO₃ can increase the refractive index and dispersion of the glass. If the content of WO₃ is too high, the light transmittance of the glass will decrease, and the crystallization resistance of secondary compression will become poor. Therefore, the content of WO₃ is 0-5%, preferably 0-3%, more preferably 0-1%. In some implementations, it further preferably contains no WO₃. In some implementations, the content of WO₃ may be 0%, greater than 0%, 0.01%, 0.05%, 0.1%, 0.5%, 1%, 1.5%, 2%, 2.5%, 3%, 3.5%, 4%, 4.5% or 5%.

In some implementations, the ratio of the total content of BaO and WO₃ (BaO+WO₃) to the content of K₂O, i.e., (BaO+WO₃)/K₂O, is controlled to be 1.5 or less, which can reduce the density of the glass and prevent the transition temperature of the glass from decreasing. Therefore, (BaO+WO₃)/K₂O is preferably 1.5 or less, (BaO+WO₃)/K₂O is more preferably 1.0 or less. Furthermore, (BaO+WO₃)/K₂O is controlled to be within a range of 0.05-0.7, which can also further optimize the stripe degree and Young's modulus of the glass. Therefore, (BaO+WO₃)/K₂O is further preferably 0.05-0.7, and (BaO+WO₃)/K₂O is more further preferably 0.1-0.5. In some implementations of the present invention, the value of (BaO+WO₃)/K₂O can be 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45 or 1.5.

In some implementations, the ratio of the content of WO₃ to the content of CaO, i.e., WO₃/CaO, is controlled to be 0.9 or less, which can increase the devitrification resistance and chemical stability of the glass. Therefore, WO₃/CaO is preferably 0.9 or less, WO₃/CaO is more preferably 0.7 or less, WO₃/CaO is further preferably 0.5 or less, and WO₃/CaO is more further preferably 0.3 or less. In some implementations, the value of WO₃/CaO can be 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85 or 0.9.

Ln₂O₃ (Ln₂O₃ is one or more of La₂O₃, Gd₂O₃, Y₂O₃, and Yb₂O₃) is a component for increasing the refractive index and chemical stability of the glass. By controlling the content of Ln₂O₃ to be 5% or less, it can prevent the devitrification resistance of the glass from decrease. The upper limit of the content of Ln₂O₃ is preferably 3%, more preferably 1%. In some implementations, it further preferably contains no Ln₂O₃. In some implementations, the content of Ln₂O₃ may be 0%, greater than 0%, 0.01%, 0.05%, 0.1%, 0.5%, 1%, 1.5%, 2%, 2.5%, 3%, 3.5%, 4%, 4.5% or 5%.

Bi₂O₃ can improve the water resistance of the glass, and reduce the transition temperature. However, if the content of Bi₂O₃ is too high, the light transmittance of the glass will decrease, the abrasion degree and chemical stability will become poor, and the density will increase significantly. Therefore, the content of Bi₂O₃ is 0-5%, preferably 0-3%, more preferably 0-1%. In some implementations, it further preferably contains no Bi₂O₃. In some implementations, the content of Bi₂O₃ may be 0%, greater than 0%, 0.01%, 0.05%, 0.1%, 0.5%, 1%, 1.5%, 2%, 2.5%, 3%, 3.5%, 4%, 4.5% or 5%.

In some implementations, the ratio of the total content of B₂O₃, SiO₂, Al₂O₃, WO₃, ZnO, ZrO₂, Ln₂O₃, and Bi₂O₃ to the total content of BaO and CaO (BaO+CaO), i.e., (B₂O₃+SiO₂+Al₂O₃+WO₃+ZnO+ZrO₂+Ln₂O₃+Bi₂O₃)/(BaO+CaO), is controlled to be 1.7 or less, which can increase the stripe degree of the glass and optimize the abrasion degree of the glass. Therefore, (B₂O₃+SiO₂+Al₂O₃+WO₃+ZnO+ZrO₂+Ln₂O₃+Bi₂O₃)/(BaO+CaO) is preferably 1.7 or less, (B₂O₃+SiO₂+Al₂O₃+WO₃+ZnO+ZrO₂+Ln₂O₃+Bi₂O₃)/(BaO+CaO) is more preferably 1.0 or less, (B₂O₃+SiO₂+Al₂O₃+WO₃+ZnO+ZrO₂+Ln₂O₃+Bi₂O₃)/(BaO+CaO) is further preferably 0.7 or less, and (B₂O₃+SiO₂+Al₂O₃+WO₃+ZnO+ZrO₂+Ln₂O₃+Bi₂O₃)/(BaO+CaO) is more further preferably 0.1-0.6. In some implementations of the present invention, the value of (B₂O₃+SiO₂+Al₂O₃+WO₃+ZnO+ZrO₂+Ln₂O₃+Bi₂O₃)/(BaO+CaO) can be 0, greater than 0, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.05, 1.1, 1.15, 1.2, 1.25, 1.3, 1.35, 1.4, 1.45, 1.5, 1.55, 1.6, 1.65 or 1.7.

By comprising one or more components of 0-1% of Sb₂O₃, SnO₂, SnO, and CeO₂ as clarifying agent in the present invention, it can increase the clarifying effect of the glass and improve the bubble degree of the glass. The content of the clarifying agent is preferably 0-0.5%, and the content of clarifying agent is more preferably 0-0.1%. Due to the reasonable design of component type and content as well as excellent bubble degree of the optical glass provided by the present invention, it further preferably contains 0% clarifying agent in some implementations. In some implementations, the content of the clarifying agent may be 0%, greater than 0%, 0.01%, 0.05%, 0.1%, 0.2%, 0.3%, 0.4%, 0.5%, 0.6%, 0.7%, 0.8%, 0.9%, or 1%.

### <Unnecessary Components>

In the glass of the present invention, for the transition metal oxides such as V, Cr, Mn, Fe, Co, Ni, Cu, Ag and Mo, even if they are contained in small amounts in a single or compound form, the glass could be colored and absorb at a specific wavelength in the visible light region, thereby impairing the properties of the present invention in increasing the visible light transmittance. Therefore, especially for optical glass with requirements on wavelength transmittance in the visible region, transition metal oxides are preferably not actually included.

Th, Cd, Tl, Os, Be and Se oxides have been used in a controlled manner as a harmful chemical substance in recent years, which is necessary not only in the glass manufacturing process, but also in the processing procedure and disposal after the productization for environmental protection measures. Therefore, in the case of attaching importance to the influence on the environment, it is preferably not actually included except for the inevitable incorporation. As a result, the optical glass does not actually contain a substance that contaminates the environment. Therefore, the optical glass of the present invention can be manufactured, processed, and discarded even if a measure is not taken as a special environmental countermeasure.

In order to achieve environmental friendliness, the optical glass of the present invention preferably does not contain As₂O₃ and PbO.

The terms “not contained” and “0%” as used herein mean that the compound, molecule or element and the like are not intentionally added to the optical glass of the present invention as raw materials; however, as raw materials and/or equipment for the production of optical glass, there will be some impurities or components that are not intentionally added in small or trace amounts in the final optical glass, and this situation also falls within the protection scope of the present invention patent.

Hereinafter, the performance of the optical glass provided by the present invention will be described.

### <Refractive Index and Abbe Number>

The refractive index (n_{d}) and Abbe number (ν_{d}) of the optical glass is tested as per the method specified in GB/T 7962.1-2010.

In some implementations, the lower limit of the refractive index (n_{d}) of the optical glass provided by the present invention is 1.89, preferably 1.90, more preferably 1.91, further preferably 1.915.

In some implementations, the upper limit of the refractive index (n_{d}) of the optical glass provided by the present invention is 1.95, preferably 1.94, more preferably 1.93.

In some implementations, the lower limit of the Abbe number (ν_{d}) of the optical glass provided by the present invention is 15, preferably 16, more preferably 17, further preferably 17.5.

In some implementations, the upper limit of the Abbe number (ν_{d}) of the optical glass provided by the present invention is 22, preferably 21, more preferably 20, further preferably 19.5.

### <Thermal Expansion Coefficient>

The thermal expansion coefficient (α_{100/300° C.}) of the optical glass is tested at 100-300° C. as per the method specified in GB/T 7962.16-2010.

In some implementations, the thermal expansion coefficient (α_{100/300° C.}) of the optical glass provided by the present invention is 100×10⁻⁷/K or less, preferably 90×10⁻⁷/K or less, more preferably 85×10⁻⁷/K or less.

### [Acid Resistance Stability]

The acid resistance stability (D_{A}) (powder method) of the optical glass is tested as per the method specified in GB/T 17129.

In some implementations, the acid resistance stability (D_{A}) of the optical glass provided by the present invention is Class 2 or above, preferably Class 1.

### [Water Resistance Stability]

The water resistance stability (D_{W}) (powder method) of the optical glass is tested as per the method specified in GB/T 17129.

In some implementations, the water resistance stability (D_{W}) of the optical glass provided by the present invention is Class 2 or above, preferably Class 1.

### [Transition Temperature]

The transition temperature (T_{g}) of the optical glass is tested as per the method specified in GB/T7962.16-2010.

In some implementations, the transition temperature (T_{g}) of the optical glass provided by the present invention is 680° C. or less, preferably 670° C. or less, more preferably 665° C. or less, further preferably 660° C. or less.

### <Abrasion Degree>

Abrasion degree (F_{A}) of optical glass refers to the data obtained by the ratio of the abrasion quantity of sample to the abrasion quantity (volume) of the standard sample (H-K9 optical glass) multiplying by 100 with the formula below under exactly the same conditions:

$${F}_{A} = \frac{V}{{V}_{0}} \times 100 = \frac{( W / ρ )}{( {W}_{0} / {ρ}_{0} )} \times 100$$

Wherein: V—volume abrasion quantity of the tested sample;
V₀—volume abrasion quantity of the standard sample;
W—mass abrasion quantity of the tested sample;
W₀—mass abrasion quantity of the standard sample;
ρ—density of the tested sample;
ρ₀—density of the standard sample.

In some implementations, the lower limit of the abrasion degree (F_{A}) of the optical glass provided by the present invention is 160, preferably 170, more preferably 180.

In some implementations, the upper limit of the abrasion degree (F_{A}) of the optical glass provided by the present invention is 220, preferably 210, more preferably 200.

### [Density]

The density (ρ) is tested as per the method specified in GB/T 7962.20-2010.

In some implementations, the density (ρ) of the optical glass provided by the present invention is 3.80 g/cm³ or less, preferably 3.70 g/cm³ or less, more preferably 3.60 g/cm³ or less, further preferably 3.50 g/cm³ or less.

### <Staining Degree>

The short-wave transmission spectrum characteristics of the glass provided by the present invention are represented by staining degree (λ₇₀). λ₇₀ refers to a wavelength corresponding to a glass transmittance of 70%. The measurement of λ₇₀ is carried out using a glass having a thickness of 10±0.1 mm with two opposing planes parallel to each other and optically polished, measuring the spectral transmittance in the wavelength region from 280 nm to 700 nm and a wavelength exhibiting 70% of the transmittance. The spectral transmittance or transmittance is an amount indicated by Iᵢₙ in the case where the light of an intensity Iᵢₙ is incident perpendicularly to the above surface of the glass, passes through the glass and passes an amount represented by Iₒᵤₜ/Iᵢₙ while emitting the light of an intensity Iₒᵤₜ from a plane, and includes the transmittance of the surface reflection loss on the above surface of the glass. The higher the refractive index of the glass is, the greater the surface reflection loss becomes. Therefore, in the glass with high refractive index, a small value of λ₇₀ means that the glass itself is colored very little and the light transmittance is high.

In some implementations, λ₇₀ of the optical glass provided by the present invention is 450 nm or less, λ₇₀ is preferably 445 nm or less, and λ₇₀ is more preferably 440 nm or less.

### <Weather Resistance>

The weather resistance (CR) test method of the optical glass is as follows: place the sample in a test chamber in a saturated water vapor environment with a relative humidity of 90%, and cycle alternately at 40-50° C. every 1 h for 15 cycles. The weather resistance is classified according to the turbidity change before and after the sample placement. The classification of weather resistance is shown in Table 1:

TABLE 1

| | | | | 4 | | |
|---|---|---|---|---|---|---|
| Category | 1 | 2 | 3 | a | b | C |
| Turbidity increase | <0.3 | 0.3-1.0 | 1.0-2.0 | 2.0-4.0 | 4.0-6.0 | ≥6.0 |
| ΔH (%) | | | | | | |

In some implementations, the weather resistance (CR) of the optical glass provided by the present invention is Class 2 or above, preferably Class 1.

### [Young's Modulus]

The Young's modulus (E) is tested by ultrasonic wave for P-wave velocity and S-wave velocity, and then calculated according to the following formula.

$$E = \frac{4 {G}^{2} - 3 {GV}_{T}^{2} ρ}{G - {V}_{T}^{2} ρ}$$

$$G = {V}_{S}^{2} p$$

Wherein: E refers to Young's modulus, Pa;
G refers to shear modulus, Pa;
V_{T} refers to S-wave velocity, m/s;
V_{S} refers to P-wave velocity, m/s;
ρ refers to glass density, g/cm³.

In some implementations, Young's modulus (E) of the optical glass provided by the present invention is 9000×10⁷ Pa or more, preferably 9500×10⁷ Pa or more, more preferably 9800×10⁷ Pa or more, further preferably 10000×10⁷ Pa-11000×10⁷ Pa.

### [Bubble Degree]

The bubble degree of the optical glass is tested as per the method specified in GB/T7962.8-2010.

In some implementations, the bubble degree of the optical glass provided by the present invention is Grade A or above, preferably Grade Ao or above, more preferably Grade A₀₀.

### [Stripe Degree]

The stripe degree of the glass provided by the present invention is tested by the following method: The stripe degree of the glass is compared with the standard sample, by a stripe instrument composed of a point light source and a lens, from the direction where the stripe is most easily seen. The stripe degree is divided into four levels, namely, Grades A, B, C, and D. Grade A indicates no stripes visible to the naked eye under specified testing conditions, Grade B indicates fine and scattered stripes under specified testing conditions, Grade C indicates slight parallel stripes under specified testing conditions, and Grade D indicates rough stripes under specified testing conditions.

In some implementations, the stripe degree of the optical glass provided by the present invention is Grade C or above, preferably Grade B or above.

### <Crystallization Resistance of Secondary Compression>

The test method for crystallization resistance of secondary compression is as follows: cut the sample glass into 20×20×10 mm pieces, place into a muffle furnace with temperature as T_{g}+ (200-250° C.) for 15-30 minutes (the present invention uses 880° C. for 15 minutes), then take out for cooling, and observe the surface and the inside of the glass for devitrification or crystal particle. In case of no devitrification and crystal particle in the glass sample, it means that the glass has excellent crystallization resistance of secondary compression.

In the test for crystallization resistance of secondary compression, according to the aforesaid test method, the glass without devitrification or crystalline particle on the surface and inside is denoted as “A”, the glass without crystalline particle inside, but with devitrification or crystalline particle on the surface, is denoted as “B” (the devitrification or crystalline particle on the surface of the glass can be removed by grinding during secondary compression), the glass with 1-10 crystal particles inside is denoted as “C”, the glass with 10-20 crystal particles inside is denoted as “D”, and the glass with 20 or more dense crystalline particles inside is denoted as “x”.

In some implementations, the crystallization resistance of secondary compression of the optical glass provided by the present invention is Grade C or above, preferably Grade B or above, more preferably Grade A.

### [Manufacturing Method of Optical Glass]

The manufacturing method of the optical glass provided by the present invention is as follows: the glass of the present invention is made of conventional raw materials and processes, including but not limited to using oxide, hydroxide, compound salt (e.g., carbonate, nitrate, sulfate, phosphate and metaphosphate), and boric acid as raw materials, mixing the ingredients according to the conventional method, and then feeding the mixed furnace burden into a 1000-1300° C. smelting furnace (e.g., platinum or platinum alloy crucible) for melting, obtaining homogeneous molten glass without bubbles and undissolved substances after clarification and homogenization, shaping the molten glass in a mould, and performing annealing. Those skilled in the art can appropriately select raw materials, process methods and process parameters according to actual needs.

### [Glass Preform and Optical Element]

The glass preform can be made from the optical glass formed by, for example, direct drop forming, grinding or thermoforming, and other compression molding means. That is to say, the precision glass preform can be made by direct precision drop molding of molten optical glass, or glass preform can be made by grinding and other machining methods, or the glass preform can be made by making a preform for compression molding with the optical glass, re-thermoforming this preform, and then grinding the preform. It should be noted that the means for preparing glass preform is not limited to the above means.

As mentioned above, the optical glass of the present invention is useful for various optical elements and optical designs, wherein the particularly preferred method is to form a preform by the optical glass of the present invention, and use this preform for re-thermoforming, precision stamping and the like to make optical elements such as lens and prism.

The glass preform and the optical element of the present invention are both formed by the optical glass of the present invention described above. The glass preform of the present invention has excellent characteristics of the optical glass; the optical element of the present invention has excellent characteristics of the optical glass, and can provide such optical elements as a variety of lenses and prisms having a high optical value.

Examples of the lens include various lenses with spherical or aspheric surfaces, such as concave meniscus lens, convex meniscus lens, biconvex lens, biconcave lens, planoconvex lens and planoconcave lens.

### [Optical Instrument]

The optical element formed by the optical glass of the present invention can make optical instruments such as photographic equipment, camera equipment, projector equipment, display equipment, on-board equipment and monitoring equipment.

### Embodiment

### [Optical Glass Embodiment]

The following non-limiting embodiments are provided in order to further clearly explain and illustrate the technical solution of the present invention.

This embodiment obtains the optical glass with composition as shown in Table 2-Table 4 by the manufacturing method of the above-mentioned optical glass. In addition, the characteristics of each glass are measured by the test method described in the present invention, and the measurement results are shown in Tables 2 to 4.

TABLE 2

| Embodiment | | | | | | | |
|---|---|---|---|---|---|---|---|
| (wt %) | 1# | 2# | 3# | 4# | 5# | 6# | 7# |
| P₂O₅ | 26.39 | 22.4 | 25.84 | 25.33 | 24.15 | 27.95 | 25.04 |
| Nb₂O₅ | 50.23 | 41.26 | 42.53 | 49.25 | 47.28 | 48.36 | 52.24 |
| TiO₂ | 13.38 | 17.22 | 16.34 | 15.28 | 14.26 | 13.47 | 12.56 |
| Na₂O | 3.75 | 8.46 | 6.15 | 3.75 | 6.25 | 4.41 | 3.85 |
| K₂O | 3.26 | 6.25 | 2.85 | 3.36 | 4.25 | 1.83 | 3.25 |
| Li₂O | 0 | 0 | 0 | 0 | 0 | 0 | 0 |
| BaO | 1.28 | 0.78 | 1.26 | 0.82 | 0.46 | 1.18 | 1.22 |
| SrO | 0 | 0 | 0 | 0 | 0 | 0 | 0 |
| CaO | 0.82 | 1.13 | 2.85 | 0.75 | 1.68 | 1.82 | 1 |
| MgO | 0 | 0 | 0 | 0 | 0 | 0 | 0 |
| SiO₂ | 0.74 | 0.38 | 1.2 | 0 | 0.15 | 0.45 | 0.6 |
| B₂O₃ | 0.15 | 1.52 | 0.88 | 0.46 | 0.72 | 0.53 | 0.24 |
| ZrO₂ | 0 | 0 | 0.1 | 0 | 0.8 | 0 | 0 |
| Al₂O₃ | 0 | 0 | 0 | 1 | 0 | 0 | 0 |
| ZnO | 0 | 0.6 | 0 | 0 | 0 | 0 | 0 |
| WO₃ | 0 | 0 | 0 | 0 | 0 | 0 | 0 |
| La₂O₃ | 0 | 0 | 0 | 0 | 0 | 0 | 0 |
| Gd₂O₃ | 0 | 0 | 0 | 0 | 0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| Bi₂O₃ | 0 | 0 | 0 | 0 | 0 | 0 | 0 |
| Sb₂O₃ | 0 | 0 | 0 | 0 | 0 | 0 | 0 |
| SnO₂ | 0 | 0 | 0 | 0 | 0 | 0 | 0 |
| SnO | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| TiO₂/K₂O | 4.10 | 2.76 | 5.73 | 4.55 | 3.36 | 7.36 | 3.86 |
| P₂O₅/Nb₂O₅ | 0.53 | 0.54 | 0.61 | 0.51 | 0.51 | 0.58 | 0.48 |
| (Nb₂O₅ + Na₂O + | 4.13 | 2.93 | 3.06 | 3.52 | 3.79 | 4.01 | 4.56 |
| BaO)/TiO₂ | | | | | | | |
| (BaO + WO₃)/K₂O | 0.39 | 0.12 | 0.44 | 0.24 | 0.11 | 0.64 | 0.38 |
| (B₂O₃ + SiO₂)/CaO | 1.09 | 1.68 | 0.73 | 0.61 | 0.52 | 0.54 | 0.84 |
| TiO₂/Nb₂O₅ | 0.27 | 0.42 | 0.38 | 0.31 | 0.30 | 0.28 | 0.24 |
| CaO/BaO | 0.64 | 1.45 | 2.26 | 0.91 | 3.65 | 1.54 | 0.82 |
| (B₂O₃ + SiO₂ + | 0.42 | 1.31 | 0.53 | 0.93 | 0.78 | 0.33 | 0.38 |
| Al₂O₃ + WO₃ + | | | | | | | |
| ZnO + ZrO₂ + | | | | | | | |
| Ln₂O₃ + Bi₂O₃)/ | | | | | | | |
| (BaO + CaO) | | | | | | | |
| (TiO₂ + K₂O)/ | 3.31 | 2.54 | 2.59 | 4.08 | 2.76 | 2.74 | 3.12 |
| (BaO + Na₂O) | | | | | | | |
| (BaO + SrO + | 0.34 | 0.16 | 0.22 | 0.22 | 0.20 | 0.27 | 0.32 |
| MgO + ZnO + | | | | | | | |
| ZrO₂)/Na₂O | | | | | | | |
| WO₃/CaO | 0 | 0 | 0 | 0 | 0 | 0 | 0 |
| n_{d} | 1.92755 | 1.91246 | 1.91385 | 1.92863 | 1.92352 | 1.92663 | 1.93182 |
| v_{d} | 17.63 | 19.34 | 19.26 | 16.78 | 18.65 | 17.16 | 16.68 |
| α_{100/300° C.} | 78 | 76 | 72 | 79 | 79 | 74 | 80 |
| (×10⁻⁷/K) | | | | | | | |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| CR | Class 1 | Class 1 | Class 1 | Class 1 | Class 1 | Class 1 | Class 1 |
| λ₇₀ (nm) | 435 | 433 | 432 | 433 | 432 | 435 | 437 |
| T_{g} (° C.) | 657 | 645 | 656 | 653 | 648 | 655 | 658 |
| ρ (g/cm³) | 3.48 | 3.46 | 3.47 | 3.48 | 3.45 | 3.48 | 3.46 |
| Crystallization | A | A | A | A | A | A | A |
| resistance of | | | | | | | |
| secondary | | | | | | | |
| compression | | | | | | | |
| Bubble degree | A₀₀ | A₀₀ | A₀₀ | A₀₀ | A₀₀ | A₀₀ | A₀₀ |
| (level) | | | | | | | |
| Stripe degree | A | B | A | B | B | A | A |
| (Grade) | | | | | | | |
| E (×10⁷Pa) | 10242 | 10247 | 10452 | 10236 | 10207 | 10228 | 10273 |
| F_{A} | 193 | 175 | 208 | 176 | 178 | 186 | 190 |

TABLE 3

| Embodiment | | | | | | | |
|---|---|---|---|---|---|---|---|
| (wt %) | 8# | 9# | 10# | 11# | 12# | 13# | 14# |
| P₂O₅ | 31.85 | 22.5 | 27.31 | 21.61 | 24.14 | 23.98 | 20.72 |
| Nb₂O₅ | 38.15 | 51.22 | 40.16 | 48.36 | 41.39 | 42.25 | 39.02 |
| TiO₂ | 21.05 | 10.05 | 13.52 | 18.24 | 11.25 | 12.36 | 19.15 |
| Na₂O | 1.25 | 2.34 | 9.24 | 3.36 | 7.25 | 6.33 | 5.24 |
| K₂O | 1.25 | 3.36 | 5.26 | 1.62 | 8.85 | 5.36 | 7.25 |
| Li₂O | 0 | 0 | 0 | 0 | 0 | 0 | 0 |
| BaO | 1.05 | 0.56 | 2.26 | 1.27 | 0.35 | 0.83 | 3.35 |
| SrO | 0 | 0 | 0 | 0 | 0 | 0 | 0 |
| CaO | 1.35 | 5.26 | 0.53 | 3.2 | 2.27 | 4.16 | 3.21 |
| MgO | 0 | 0 | 0 | 0 | 0 | 0 | 0 |
| SiO₂ | 0 | 0.5 | 0.82 | 0.35 | 1.47 | 2.2 | 0.22 |
| B₂O₃ | 2.58 | 0.36 | 0 | 1.44 | 1.16 | 2.03 | 0.54 |
| ZrO₂ | 0 | 0 | 0 | 0 | 0 | 0 | 0 |
| Al₂O₃ | 0 | 0 | 0 | 0 | 0 | 0 | 0 |
| ZnO | 0 | 0 | 0 | 0 | 0 | 0 | 1.2 |
| WO₃ | 0.35 | 2.25 | 0.4 | 0 | 0.82 | 0.5 | 0 |
| La₂O₃ | 0 | 1.5 | 0 | 0 | 0 | 0 | 0 |
| Gd₂O₃ | 0 | 0 | 0 | 0 | 1 | 0 | 0 |
| Y₂O₃ | 0 | 0 | 0 | 0.5 | 0 | 0 | 0 |
| Yb₂O₃ | 0 | 0 | 0 | 0 | 0 | 0 | 0 |
| Bi₂O₃ | 1.12 | 0 | 0.5 | 0 | 0 | 0 | 0 |
| Sb₂O₃ | 0 | 0.1 | 0 | 0.05 | 0 | 0 | 0 |
| SnO₂ | 0 | 0 | 0 | 0 | 0.05 | 0 | 0.1 |
| SnO | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| TiO₂/K₂O | 16.84 | 2.99 | 2.57 | 11.26 | 1.27 | 2.31 | 2.64 |
| P₂O₅/Nb₂O₅ | 0.83 | 0.44 | 0.68 | 0.45 | 0.58 | 0.57 | 0.53 |
| (Nb₂O₅ + Na₂O + | 1.92 | 5.39 | 3.82 | 2.91 | 4.35 | 4.0 | 2.49 |
| BaO)/TiO₂ | | | | | | | |
| (BaO + WO₃)/K₂O | 1.12 | 0.84 | 0.51 | 0.78 | 0.13 | 0.25 | 0.46 |
| (B₂O₃ + SiO₂)/CaO | 1.91 | 0.16 | 1.55 | 0.56 | 1.16 | 1.02 | 0.24 |
| TiO₂/Nb₂O₅ | 0.55 | 0.20 | 0.34 | 0.38 | 0.27 | 0.29 | 0.49 |
| CaO/BaO | 1.29 | 9.39 | 0.23 | 2.52 | 6.49 | 5.01 | 0.96 |
| (B₂O₃ + SiO₂ + | 1.69 | 0.79 | 0.62 | 0.51 | 1.70 | 0.95 | 0.30 |
| Al₂O₃ + WO₃ + | | | | | | | |
| ZnO + ZrO₂ + | | | | | | | |
| Ln₂O₃ + Bi₂O₃)/ | | | | | | | |
| (BaO + CaO) | | | | | | | |
| (TiO₂ + K₂O)/ | 9.70 | 4.62 | 1.63 | 4.29 | 2.64 | 2.47 | 3.07 |
| (BaO + Na₂O) | | | | | | | |
| (BaO + SrO + | 0.84 | 0.24 | 0.24 | 0.38 | 0.05 | 0.13 | 0.87 |
| MgO + ZnO + | | | | | | | |
| ZrO₂)/Na₂O | | | | | | | |
| WO₃/CaO | 0.26 | 0.43 | 0.75 | 0 | 0.36 | 0.12 | 0 |
| n_{d} | 1.93852 | 1.94263 | 1.89875 | 1.94458 | 1.89523 | 1.90285 | 1.90532 |
| v_{d} | 18.26 | 16.12 | 21.06 | 15.52 | 21.35 | 20.75 | 20.37 |
| α_{100/300° C.} | 87 | 85 | 82 | 81 | 72 | 73 | 78 |
| (×10⁻⁷/K) | | | | | | | |
| D_{A} | Class 2 | Class 1 | Class 1 | Class 1 | Class 1 | Class 1 | Class 2 |
| D_{W} | Class 1 | Class 1 | Class 1 | Class 1 | Class 1 | Class 1 | Class 1 |
| CR | Class 2 | Class 1 | Class 1 | Class 1 | Class 1 | Class 1 | Class 1 |
| λ₇₀ (nm) | 445 | 442 | 440 | 434 | 435 | 432 | 440 |
| T_{g} (° C.) | 670 | 665 | 650 | 661 | 645 | 654 | 662 |
| ρ (g/cm³) | 3.61 | 3.58 | 3.51 | 3.52 | 3.46 | 3.45 | 3.42 |
| Crystallization | C | C | C | B | B | B | A |
| resistance of | | | | | | | |
| secondary | | | | | | | |
| compression | | | | | | | |
| Bubble degree | A₀ | A₀ | A₀ | A₀ | A₀₀ | A₀₀ | A₀₀ |
| (level) | | | | | | | |
| Stripe degree | C | C | B | A | B | B | A |
| (Grade) | | | | | | | |
| E (×10⁷Pa) | 9532 | 9650 | 10152 | 9825 | 9876 | 10056 | 10352 |
| F_{A} | 168 | 179 | 215 | 201 | 170 | 177 | 195 |

TABLE 4

| Embodiment | | | | | | | |
|---|---|---|---|---|---|---|---|
| (wt %) | 15# | 16# | 17# | 18# | 19# | 20# | 21# |
| P₂O₅ | 26.21 | 24.14 | 27.17 | 27.95 | 26.25 | 26.1 | 26.24 |
| Nb₂O₅ | 45.17 | 46.32 | 44.15 | 49.25 | 43.38 | 44.25 | 46.17 |
| TiO₂ | 15.24 | 16.05 | 15.35 | 14.72 | 15.36 | 16.22 | 14.52 |
| Na₂O | 4.16 | 4.55 | 5.27 | 2.54 | 4.15 | 3.85 | 4.53 |
| K₂O | 4.14 | 4.22 | 4.38 | 2.15 | 5.21 | 4.28 | 3.64 |
| Li₂O | 0 | 0 | 0 | 0 | 0 | 0 | 0 |
| BaO | 1.57 | 2.26 | 2.46 | 0.28 | 1.24 | 1.33 | 1.82 |
| SrO | 0 | 0 | 0 | 0 | 0 | 0 | 0 |
| CaO | 2.13 | 1.55 | 0.75 | 1.78 | 2.35 | 2.16 | 1.92 |
| MgO | 0 | 0 | 0 | 0 | 0 | 0 | 0 |
| SiO₂ | 0.72 | 0.16 | 0.37 | 0.55 | 1.14 | 0.57 | 0.34 |
| B₂O₃ | 0.66 | 0.75 | 0.1 | 0.78 | 0.92 | 1.24 | 0.82 |
| ZrO₂ | 0 | 0 | 0 | 0 | 0 | 0 | 0 |
| Al₂O₃ | 0 | 0 | 0 | 0 | 0 | 0 | 0 |
| ZnO | 0 | 0 | 0 | 0 | 0 | 0 | 0 |
| WO₃ | 0 | 0 | 0 | 0 | 0 | 0 | 0 |
| La₂O₃ | 0 | 0 | 0 | 0 | 0 | 0 | 0 |
| Gd₂O₃ | 0 | 0 | 0 | 0 | 0 | 0 | 0 |
| Y₂O₃ | 0 | 0 | 0 | 0 | 0 | 0 | 0 |
| Yb₂O₃ | 0 | 0 | 0 | 0 | 0 | 0 | 0 |
| Bi₂O₃ | 0 | 0 | 0 | 0 | 0 | 0 | 0 |
| Sb₂O₃ | 0 | 0 | 0 | 0 | 0 | 0 | 0 |
| SnO₂ | 0 | 0 | 0 | 0 | 0 | 0 | 0 |
| SnO | 0 | 0 | 0 | 0 | 0 | 0 | 0 |
| CeO₂ | 0 | 0 | 0 | 0 | 0 | 0 | 0 |
| Total | 100 | 100 | 100 | 100 | 100 | 100 | 100 |
| TiO₂/K₂O | 3.68 | 3.80 | 3.50 | 6.85 | 2.95 | 3.79 | 3.99 |
| P₂O₅/Nb₂O₅ | 0.58 | 0.52 | 0.62 | 0.57 | 0.61 | 0.59 | 0.57 |
| (Nb₂O₅ + Na₂O + | 3.34 | 3.31 | 3.38 | 3.54 | 3.18 | 3.05 | 3.62 |
| BaO)/TiO₂ | | | | | | | |
| (BaO + WO₃)/K₂O | 0.38 | 0.54 | 0.56 | 0.13 | 0.24 | 0.31 | 0.50 |
| (B₂O₃ + SiO₂)/CaO | 0.65 | 0.59 | 0.63 | 0.75 | 0.88 | 0.84 | 0.60 |
| TiO₂/Nb₂O₅ | 0.34 | 0.35 | 0.35 | 0.30 | 0.35 | 0.37 | 0.31 |
| CaO/BaO | 1.36 | 0.69 | 0.30 | 6.36 | 1.90 | 1.62 | 1.05 |
| (B₂O₃ + SiO₂+ | 0.37 | 0.24 | 0.15 | 0.65 | 0.57 | 0.52 | 0.31 |
| Al₂O₃ + WO₃+ | | | | | | | |
| ZnO + ZrO₂+ | | | | | | | |
| Ln₂O₃ + Bi₂O₃)/ | | | | | | | |
| (BaO + CaO) | | | | | | | |
| (TiO₂ + K₂O)/ | 3.38 | 2.98 | 2.55 | 5.98 | 3.82 | 3.96 | 2.86 |
| (BaO + Na₂O) | | | | | | | |
| (BaO + SrO + | 0.38 | 0.50 | 0.47 | 0.11 | 0.30 | 0.35 | 0.40 |
| MgO + ZnO + | | | | | | | |
| ZrO₂)/Na₂O | | | | | | | |
| WO₃/CaO | 0 | 0 | 0 | 0 | 0 | 0 | 0 |
| n_{d} | 1.92275 | 1.92453 | 1.91846 | 1.92875 | 1.91783 | 1.92425 | 1.92337 |
| v_{d} | 18.56 | 18.27 | 19.06 | 17.65 | 18.82 | 18.55 | 18.78 |
| α_{100/300° C.} | 74 | 77 | 73 | 70 | 74 | 72 | 73 |
| (×10⁻⁷/K) | | | | | | | |
| D_{A} | Class 1 | Class 1 | Class 1 | Class 1 | Class 1 | Class 1 | Class 1 |
| D_{W} | Class 1 | Class 1 | Class 1 | Class 1 | Class 1 | Class 1 | Class 1 |
| CR | Class 1 | Class 1 | Class 1 | Class 1 | Class 1 | Class 1 | Class 1 |
| λ₇₀ (nm) | 428 | 430 | 431 | 432 | 431 | 430 | 434 |
| T_{g} (° C.) | 653 | 657 | 650 | 656 | 652 | 653 | 655 |
| ρ (g/cm³) | 3.45 | 3.46 | 3.50 | 3.45 | 3.43 | 3.47 | 3.45 |
| Crystallization | A | A | A | A | A | A | A |
| resistance of | | | | | | | |
| secondary | | | | | | | |
| compression | | | | | | | |
| Bubble degree | A₀₀ | A₀₀ | A₀₀ | A₀₀ | A₀₀ | A₀₀ | A₀₀ |
| (level) | | | | | | | |
| Stripe degree | A | A | A | A | A | A | A |
| (Grade) | | | | | | | |
| E (×10⁷Pa) | 10178 | 10362 | 10254 | 10446 | 10357 | 10265 | 10232 |
| F_{A} | 203 | 187 | 194 | 212 | 195 | 191 | 192 |

### [Glass Preform Embodiment]

The glass obtained by Embodiments 1-21 # of the optical glass is made into a variety of lenses and prisms and other preforms such as concave meniscus lens, convex meniscus lens, biconvex lens, biconcave lens, planoconvex lens, and planoconcave lens by means of, for example, grinding, or re-thermoforming, precision stamping and other compression molding methods.

### [Optical Element Embodiment]

The preforms obtained in the above-mentioned glass preform embodiment are annealed for fine-tuning of refractive index while reducing the stress inside the glass, so that the optical characteristics such as the refractive index are brought to the desired values.

Then, each of the preforms is ground and polished, and a variety of lenses and prisms such as concave meniscus lens, convex meniscus lens, biconvex lens, biconcave lens, planoconvex lens, and planoconcave lens are prepared. An anti-reflection film may be coated on the surface of the obtained optical element.

### <Embodiments of Optical Instrument>

Through optical design and the use of one or more optical elements to form optical component or optical assembly, the optical element prepared by the above-mentioned optical element embodiment can be used, for example, in imaging device, sensor, microscope, medical technology, digital projection, communication, optical communication technology/information transmission, optics/lighting in the automobile field, photolithography, excimer laser, wafer, computer chip, and integrated circuit and electronic device including such circuit and chip.

1. An optical glass, wherein components thereof are represented by weight percentage, comprising: 20-34% of P₂O₅; 38-53% of Nb₂O₅; 8-22% of TiO₂; 1-12% of Na₂O; 0-10% of K₂O; 0-8% of BaO.

2. The optical glass according to claim 1, wherein components thereof are represented by weight percentage, further comprising: 0-8% of CaO; and/or 0-5% of MgO; and/or 0-5% of SrO; and/or 0-6% of Li₂O; and/or 0-5% of SiO₂; and/or 0-5% of B₂O₃; and/or 0-5% of ZrO₂; and/or 0-5% of Al₂O₃; and/or 0-5% of ZnO; and/or 0-5% of WO₃; and/or 0-5% of Ln₂O₃; and/or 0-5% of Bi₂O₃; and/or 0-1% of clarifying agent, and the Ln₂O₃ is one or more of La₂O₃, Gd₂O₃, Y₂O₃ and Yb₂O₃, and the clarifying agent is one or more of Sb₂O₃, SnO₂, SnO and CeO₂.

3. The optical glass according to claim 1, wherein components thereof are represented by weight percentage, and one or more of the following 11 conditions are satisfied:
1) P₂O₅/Nb₂O₅ is 0.4-0.85;
2) TiO₂/Nb₂O₅ is 0.2-0.55;
3) TiO₂/K₂O is 1.0-18.0;
4) (Nb₂O₅+Na₂O+BaO)/TiO₂ is 1.8-5.5;
5) (TiO₂+K₂O)/(BaO+Na₂O) is 1.6-12.0;
6) CaO/BaO is 0.1-10.0;
7) (B₂O₃+SiO₂)/CaO is 2.8 or less;
8) (BaO+SrO+MgO+ZnO+ZrO₂)/Na₂O is 1.0 or less;
9) (BaO+WO₃)/K₂O is 1.5 or less;
10) WO₃/CaO is 0.9 or less; and
11) (B₂O₃+SiO₂+Al₂O₃+WO₃+ZnO+ZrO₂+Ln₂O₃+Bi₂O₃)/(BaO+CaO) is 1.7 or less, and the Ln₂O₃ is one or more of La₂O₃, Gd₂O₃, Y₂O₃, and Yb₂O₃.

4. The optical glass according to claim 1, wherein components thereof are represented by weight percentage, and one or more of the following 11 conditions are satisfied:
1) P₂O₅/Nb₂O₅ is 0.45-0.8;
2) TiO₂/Nb₂O₅ is 0.2-0.5;
3) TiO₂/K₂O is 1.0-12.0;
4) (Nb₂O₅+Na₂O+BaO)/TiO₂ is 2.0-5.0;
5) (TiO₂+K₂O)/(BaO+Na₂O) is 2.0-10.0;
6) CaO/BaO is 0.2-7.0;
7) (B₂O₃+SiO₂)/CaO is 0.1-2.0;
8) (BaO+SrO+MgO+ZnO+ZrO₂)/Na₂O is 0.8 or less;
9) (BaO+WO₃)/K₂O is 1.0 or less;
10) WO₃/CaO is 0.7 or less; and
11) (B₂O₃+SiO₂+Al₂O₃+WO₃+ZnO+ZrO₂+Ln₂O₃+Bi₂O₃)/(BaO+CaO) is 1.0 or less, and the Ln₂O₃ is one or more of La₂O₃, Gd₂O₃, Y₂O₃, and Yb₂O₃.

5. The optical glass according to claim 1, wherein components thereof are represented by weight percentage, and one or more of the following 11 conditions are satisfied:
1) P₂O₅/Nb₂O₅ is 0.5-0.7;
2) TiO₂/Nb₂O₅ is 0.25-0.45;
3) TiO₂/K₂O is 1.5-10.0;
4) (Nb₂O₅+Na₂O+BaO)/TiO₂ is 2.5-4.5;
5) (TiO₂+K₂O)/(BaO+Na₂O) is 2.2-7.0;
6) CaO/BaO is 0.3-5.0;
7) (B₂O₃+SiO₂)/CaO is 0.2-1.5;
8) (BaO+SrO+MgO+ZnO+ZrO₂)/Na₂O is 0.05-0.6;
9) (BaO+WO₃)/K₂O is 0.05-0.7;
10) WO₃/CaO is 0.5 or less; and
11) (B₂O₃+SiO₂+Al₂O₃+WO₃+ZnO+ZrO₂+Ln₂O₃+Bi₂O₃)/(BaO+CaO) is 0.7 or less, and the Ln₂O₃ is one or more of La₂O₃, Gd₂O₃, Y₂O₃, and Yb₂O₃.

6. The optical glass according to claim 1, wherein components thereof are represented by weight percentage, and one or more of the following 9 conditions are satisfied:
1) P₂O₅/Nb₂O₅ is 0.55-0.65;
2) TiO₂/K₂O is 2.0-8.0;
3) (TiO₂+K₂O)/(BaO+Na₂O) is 2.5-5.5;
4) CaO/BaO is 0.5-3.0;
5) (B₂O₃+SiO₂)/CaO is 0.4-1.0;
6) (BaO+SrO+MgO+ZnO+ZrO₂)/Na₂O is 0.1-0.5;
7) (BaO+WO₃)/K₂O is 0.1-0.5;
8) WO₃/CaO is 0.3 or less; and
9) (B₂O₃+SiO₂+Al₂O₃+WO₃+ZnO+ZrO₂+Ln₂O₃+Bi₂O₃)/(BaO+CaO) is 0.1-0.6, and the Ln₂O₃ is one or more of La₂O₃, Gd₂O₃, Y₂O₃, and Yb₂O₃.

7. The optical glass according to claim 1, wherein components thereof are represented by weight percentage, in which: P₂O₅ is 22-32%; and/or Nb₂O₅ is 40-50%; and/or TiO₂ is 11-20%; and/or Na₂O is 2-10%; and/or K₂O is 0.5-8%; and/or BaO is greater than 0 but less than or equal to 6%; and/or CaO is 0-6%; and/or MgO is 0-3%; and/or SrO is 0-3%; and/or Li₂O is 0-4%; and/or SiO₂ is 0-3%; and/or B₂O₃ is 0-3%; and/or ZrO₂ is 0-3%; and/or Al₂O₃ is 0-3%; and/or ZnO is 0-3%; and/or WO₃ is 0-3%; and/or Ln₂O₃ is 0-3%; and/or Bi₂O₃ is 0-3%; and/or clarifying agent is 0-0.5%, the Ln₂O₃ is one or more of La₂O₃, Gd₂O₃, Y₂O₃ and Yb₂O₃, and the clarifying agent is one or more of Sb₂O₃, SnO₂, SnO, CeO₂.

8. The optical glass according to claim 1, wherein components thereof are represented by weight percentage, in which: P₂O₅ is 25-29%; and/or Nb₂O₅ is 42-47%; and/or TiO₂ is 13-18%; and/or Na₂O is 3-8%; and/or K₂O is 1-6%; and/or BaO is 0.1-3.5%; and/or CaO is 0.1-4%; and/or MgO is 0-1%; and/or SrO is 0-1%; and/or Li₂O is 0-2%; and/or SiO₂ is 0-1%; and/or B₂O₃ is 0-1.5%; and/or ZrO₂ is 0-1%; and/or Al₂O₃ is 0-1%; and/or ZnO is 0-1%; and/or WO₃ is 0-1%; and/or Ln₂O₃ is 0-1%; and/or Bi₂O₃ is 0-1%; and/or clarifying agent is 0-0.1%, the Ln₂O₃ is one or more of La₂O₃, Gd₂O₃, Y₂O₃, Yb₂O₃, and the clarifying agent is one or more of Sb₂O₃, SnO₂, SnO, CeO₂.

9. The optical glass according to claim 1, wherein components thereof do not contain MgO; and/or do not contain SrO; and/or do not contain Li₂O; and/or do not contain ZrO₂; and/or do not contain Al₂O₃; and/or do not contain ZnO; and/or do not contain WO₃; and/or do not contain Ln₂O₃; and/or do not contain Bi₂O₃, and the Ln₂O₃ is one or more of La₂O₃, Gd₂O₃, Y₂O₃ and Yb₂O₃.

10. The optical glass according to claim 1, wherein a refractive index n_{d} of the optical glass is 1.89-1.95; and/or Abbe number ν_{d} is 15-22; and/or thermal expansion coefficient α_{100/300° C.} is 100×10⁻⁷/K or less; and/or acid resistance stability D_{A} is Class 2 or above; and/or water resistance stability D_{W} is Class 2 or above; and/or transition temperature T_{g} is 680° C. or less; and/or abrasiveness F_{A} is 160-220; and/or density ρ is 3.80 g/cm³ or less; and/or λ₇₀ is 450 nm or less; and/or weather resistance CR is Class 2 or above; and/or Young's modulus E is 9000×10⁷ Pa or more; and/or bubble degree is Grade A or above; and/or stripe degree is Grade C or above; and/or crystallization resistance of secondary compression is Grade C or above.

11. The optical glass according to claim 1, wherein a refractive index n_{d} of the optical glass is 1.91-1.94; and/or Abbe number ν_{d} is 17-20; and/or thermal expansion coefficient α_{100/300° C.} is 90×10⁻⁷/K or less; and/or acid resistance stability D_{A} is Class 1; and/or water resistance stability D_{W} is Class 1; and/or transition temperature T_{g} is 670° C. or less; and/or abrasiveness F_{A} is 170-210; and/or density p is 3.60 g/cm³ or less; and/or λ₇₀ is 445 nm or less; and/or weather resistance CR is Class 1; and/or Young's modulus E is 9800×10⁷ Pa or more; and/or bubble degree is Grade Ao or above; and/or stripe degree is Grade B or above; and/or crystallization resistance of secondary compression is Grade B or above.

12. The optical glass according to claim 1, wherein a refractive index n_{d} of the optical glass is 1.915-1.93; and/or Abbe number ν_{d} is 17.5-19.5; and/or thermal expansion coefficient α_{100/300° C.} is 85×10⁻⁷/K or less; and/or transition temperature T_{g} is 660° C. or less; and/or abrasiveness F_{A} is 180-200; and/or density p is 3.50 g/cm³ or less; and/or λ70 is 440 nm or less; and/or Young's modulus E is 10000×10⁷ Pa-11000×10⁷ Pa; and/or bubble degree is Grade A₀₀; and/or crystallization resistance of secondary compression is Grade A.

13. An optical element, made of the optical glass according to claim 1.

14. An optical instrument, comprising the optical glass according to claim 1.
